(19) United States
(12) Patent Application Publication
(10) Pub. No.: US 2021/0135694 A1
(43) Pub. Date: May 6, 2021

(54) ANTENNA NETWORK MATCHING

(71) Applicant: HACH LANGE GMBH, Berlin (DE)

(72) Inventor: Arnaud Herbert, Thorens-Glieres (FR)

(21) Appl. No.: 17/253,834

(22) PCT Filed: Aug. 30, 2019
(86) PCT No.: PCT/EP2019/073191

§ 371 Date: Dec. 18, 2020

Related U.S. Application Data
(60) Provisional application No. 62/725,707, filed on Aug. 31, 2018.

(51) Int. Cl. H04B 1/04; H01Q 1/38; H01Q 5/10

(52) U.S. Cl. CPC H04B 1/0458; H01Q 5/10; H01Q 1/38

(57) ABSTRACT

An embodiment provides a method for matching an antenna to a network, including: identifying a communication network having a predetermined frequency accessible to connect a multi-band antenna of a device that radiates at a plurality of frequencies, wherein the plurality of frequencies includes the predetermined frequency; selecting one of a plurality of matching networks associated with the multi-band antenna based upon the predetermined frequency of the communication network, wherein each of the plurality of matching networks is associated with at least one of the plurality of frequencies; and connecting the multi-band antenna to the identified communication ne twork while employing the selected one of a plurality of matching networks. Other aspects are described and claimed.

### FIELD

This application relates generally to communication systems, and, more particularly, to tuning an antenna to a communication network through a matching network crcuit.

### BACKGROUND

Communication systems are widely used for daily life and tasks. Both individuals and companies rely on wireless communication in lieu of traditional land lines or hardwired connections. Different countries and even different geographical areas within one country often have different types of wireless communications, for example, 4G, 3G, or the like. Additionally, many wireless devices are able to communicate using different bands or frequencies. Given the many types of wireless systems and different wireless devices, it may be difficult to provide a network of reliable service to a wireless device. Wireless communication users may find themselves in an area in which their wireless device cannot communicate with the wireless network. A wireless device may not be able to seamlessly connect with an available wireless network.

### BRIEF SUMMARY

In summary, one embodiment provides a method for matching an antenna to a network, comprising: identifying a communication network having a predetermined frequency accessible to connect a multi-band antenna of a device that radiates at a plurality of frequencies, wherein the plurality of frequencies includes the predetermined frequency; selecting one of a plurality of matching networks associated with the multi-band antenna based upon the predetermined frequency of the communication network, wherein each of the plurality of matching networks is associated with at least one of the plurality of frequencies; and connecting the multi-band antenna to the identified communication network while employing the selected one of a plurality of matching networks.

Another embodiment provides a device for matching an antenna to a network, comprising: a processor; and a memory device that stores instructions executable by the processor to: identify a communication network having a predetermined frequency accessible to connect a multi-band antenna of a device that radiates at a plurality of frequencies, wherein the plurality of frequencies includes the predetermined frequency; select one of a plurality of matching networks associated with the multi-band antenna based upon the predetermined frequency of the communication network, wherein each of the plurality of matching networks is associated with at least one of the plurality of frequencies; and connect the multi-band antenna to the identified communication network while employing the selected one of a plurality of matching networks.

A further embodiment provides a product for matching an antenna to a network, comprising: a storage device having code stored therewith, the code being executable by the processor and comprising: code that identifies a communication network having a predetermined frequency accessible to connect a multi-band antenna of a device that radiates at a plurality of frequencies, wherein the plurality of frequencies includes the predetermined frequency; code that selects one of a plurality of matching networks associated with the multi-band antenna based upon the predetermined frequency of the communication network, wherein each of the plurality of matching networks is associated with at least one of the plurality of frequencies; and code that connects the multi-band antenna to the identified communication network while employing the selected one of a plurality of matching networks.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of computer circuitry

FIG. 2 illustrates a flow diagram of antenna network matching.

FIG. 3 illustrates a schematic diagram of antenna network matching.

FIG. 4 illustrates an example circuit diagram of antenna network matching.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well-known structures, materials, or operations are not shown or described in detail. The following description is intended only by way of example, and simply illustrates certain example embodiments.

The use of wireless devices is a part of everyday life. Wireless devices, such as cell phones, tablets, laptop computers, and the like, transmit and receive many types of data. These data may include voice, data, Short Message Service (SMS) messages, or the like. A cellular phone network may be used as an exemplar described herein, however this disclosure contemplates use in any type of communication network, with any wireless connectable device. It is estimated that there are over 7 billion cell phones in operation worldwide. A wireless device is similar to a two-way radio in which signals are transmitted and received. Voice, pictures, messages, or the like may be converted into an electrical signal and transmitted by radio waves to the nearest receiver such as a cell phone tower. The radio waves may transmit voice or data in a form of oscillating electric and/or magnetic fields. These fields may be referred to as an electromagnetic field (EMF). A mobile device, such as a cell phone, may contain one or more antennas that may transmit and receive radio signals. The antenna may convert the transmitted wave back into an electrical signal. In the case that the device contains more than one antenna or contains a single antenna that is tunable to different frequencies, each of the antennas may receive different signals associated with different features such as Wi-Fi, Bluetooth, GPS, or the like.

However, different countries and even different wireless service providers may use different types of networks, with each network operating within a designated frequency band. In the case that a user has a device with an antenna tuned to the wavelength for one type of mobile network, but the user is in a geographical area that has coverage for another type of mobile network, the mobile device may not effectively communicate with the network in the user's geographical area. This may lead to a slower transmission rate of data, or possibly, no data transfer at all. One traditional solution to this problem is to install a multi-band antenna within the mobile device. The multi-band antenna provides a mechanism that allows the antenna to tune to different frequency bands, thereby allowing the mobile device to communicate within many different frequency bands. However, a multi-band antenna may not provide optimum efficiency for one or more specific radiated frequencies. Specifically, even though the multi-band antenna can be tuned to different frequency bands, the communications at some of these frequency bands are not provided at optimum efficiency causing the communications to be slow, weak, or otherwise non-optimized. What is needed is a system and method for tuning an antenna to a communication network that allows optimum efficiency across all the different frequency bands.

Accordingly, the systems and methods described herein provide a technique for matching a wireless network using circuitry to tune a mobile device antenna to a communication network, thereby providing a more optimal communication connection than possible using conventional systems. The system may identify a communication network that has a predetermined frequency that the mobile device is attempting to connect to. The mobile device may include one or more antennas or one or more multi-band antennas that allow the mobile device to operate in a plurality of frequency bands. The system can then select one of a plurality of matching networks that is associated with the antenna(s) based upon the frequency of the communication network. The system then connects the antenna(s) to the communication network using the selected matching network. In connecting to the communication network, the system may use a device that allows switching between the matching networks. In one embodiment, the switching device may include a metal-oxide-semiconductor field-effect transistor (MOSFET). Accordingly, in an embodiment, the multi-band antenna may be optimized for performance with a communication network through the selected matching network.

The illustrated example embodiments will be best understood by reference to the figures. The following description is intended only by way of example, and simply illustrates certain example embodiments.

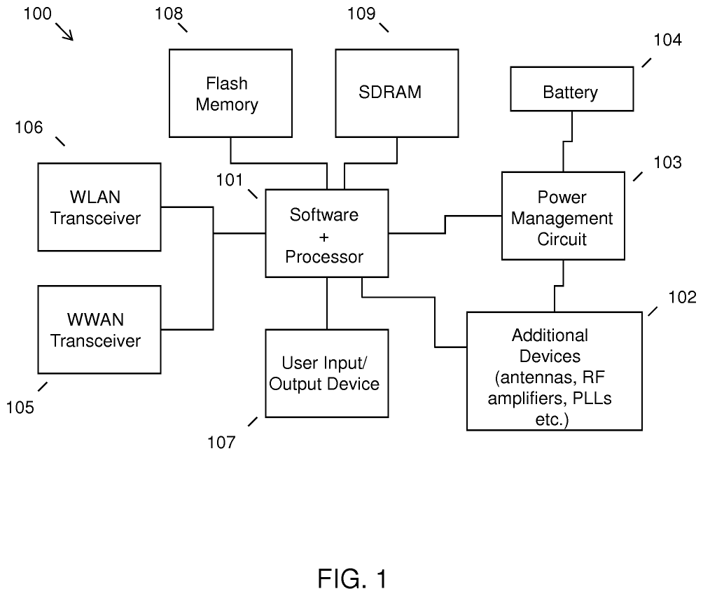

The disclosed device and method for matching an antenna to a network may be used with any suitable piece of equipment. In one embodiment, the device is used with an apparatus for measuring a property of water, such as pH, alkalinity, chlorine content, turbidity, oxidation-reduction potential (ORP), hardness, sodium, or the like. While various other circuits, circuitry or components may be utilized in information handling devices, with regard to an instrument for pH measurement according to any one of the various embodiments described herein or a device for matching an antenna to a network, an example is illustrated in FIG. 1. Device circuitry 100 may include a measurement system on a chip design found, for example, a particular computing platform (e.g., mobile computing, desktop computing, etc.) Software and processor(s) are combined in a single chip 101. Processors comprise internal arithmetic units, registers, cache memory, busses, I/O ports, etc., as is well known in the art. Internal busses and the like depend on different vendors, but essentially all the peripheral devices (102) may attach to a single chip 101. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 103, e.g., a battery management unit, BMU, which manage power as supplied, for example, via a rechargeable battery 104, which may be recharged by a connection to a power source (not shown). In at least one design, a single chip, such as 101, is used to supply BIOS like functionality and DRAM memory.

System 100 typically includes one or more of a WWAN transceiver 105 and a WLAN transceiver 106 for connecting to various networks, such as telecommunications networks and wireless Internet devices, e.g., access points. Additionally, devices 102 are commonly included, e.g., a transmit and receive antenna, oscillators, RF amplifers, PLLs, etc. System 100 includes input/output devices 107 for data input and display/rendering (e.g., a computing location located away from the single beam system that is easily accessible by a user). System 100 also typically includes various memory devices, for example flash memory 108 and SDRAM 109.

It can be appreciated from the foregoing that electronic components of one or more systems or devices may include, but are not limited to, at least one processing unit, a memory, and a communication bus or communication means that couples various components including the memory to the processing unit(s). A system or device may include or have access to a variety of device readable media. System memory may include device readable storage media in the form of volatile and/or nonvolatile memory such as read only memory (ROM) and/or random access memory (RAM). By way of example, and not limitation, system memory may also include an operating system, application programs, other program modules, and program data. The disclosed system may be used in an embodiment to perform pH measurement of an aqueous sample.

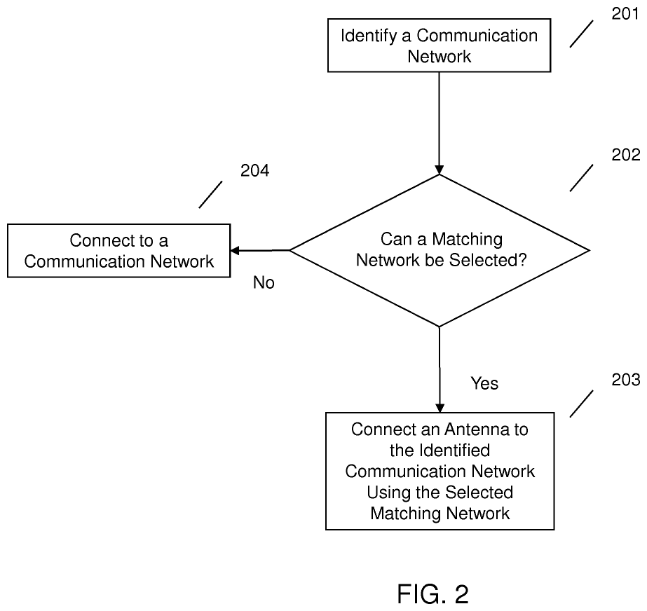

Referring now to FIG. 2, an embodiment may identify a communication network at 201. This communication network may include a communication that a mobile device is attempting to access or connect to. The identification of a communication network may be performed at any time. The device may identify a frequency of a communication network at startup, periodically, or continuously. The device may identify a communication network automatically, when prompted by a user/system, or by a system connected to the device. The device may identify a communication network as a device moves from one area covered by a communication network to another communication network.

The communication network may operate at a predetermined frequency, usually in the form of a frequency band, for example, a communication network may operate within a 1700-2100 MHz frequency band. The communication network may also simply operate on a single frequency. The device may contain circuitry to identify the particular frequency of the communication network. For example, a device may be able to detect a frequency received by the device and identify a corresponding frequency on which to transmit for the communication network. In an embodiment, the device may radiate at a plurality of frequencies. Alternatively, the device may identify the communication network type (e.g., 3G, 4G, Global System for Mobile communications (GSM) network, Universal Mobile Telecommunication System (UMTS) network, Long-Term Evolution (LTE) network, etc.) and based upon the network type, the device may identify the communication network frequency because those network types generally operate at predetermined frequencies. These frequencies may vary based upon a region or location, for example, a 4G network in one country may operate within one frequency, while a 4G network in a different country operates on a different frequency. Accordingly, the device may also take into account the physical location or region that the device is within to determine the communication network frequency.

The device may include one or more antennas or may include a multi-band antenna which allows the device to operate on a plurality of frequencies. A multi-band antenna is an antenna that is operable on a plurality of frequencies and is tuned to operate on the desired frequency, usually corresponding to the frequency of the communication network. Accordingly, a multi-band antenna is capable of radiating at a plurality of frequencies. In an embodiment the multi-band antenna may be a printed antenna. The antenna may be a microstrip antenna, for example, the antenna may employ microstrips fabricated on a printed circuit board (PCB). The printed antenna may be constructed of one or more traces, each trace corresponding to at least one frequency of the multi-band antenna. The one of more traces may be printed upon one or more side of the PCB. The one or more traces may be switched on or off individually or in groups to achieve a desired frequency.

The described system includes a plurality of matching network circuits, also referred to as matching networks, for a plurality of or each of the frequencies that the multiple antennas or multi-band antenna can operate within. A matching network is a circuit that allows for impedance matching to maximize the power transfer of the circuit or minimize the signal reflection. The impedance may be adapted between an emitter of a device (e.g., an radio frequency (RF) amplifier) and an antenna. The impedance adaption may improve performance of an antenna at a predetermined frequency. In one embodiment the impedance value that is trying to be attained is 50 ohms. This impedance value may correspond to an optimal impedance that allows for the highest power transfer between the antenna and the emitter of the device, thereby allowing for the best connection to the communication network.

Alternatively, the desired impedance may correspond to an impedance that results in a Standing Wave Ratio (SWR) of 1. SWR may be measured as an impedance matching of loads. Impedance matching may be achieved when a source of impedance is a complex conjugate of a load impedance. This impedance may correspond to the previously mentioned 50 ohms, or may be a different impedance. An SWR results in an optimal or maximized power transfer between the antenna and the emitter of the device. For example, a matched load may result in a SWR of 1. A SWR of 1 may result in no reflection of a transmitted wave. This may result in efficient transmission and minimize signal loss as the signal travels through a medium.

Accordingly, the system operates with a plurality of matching networks, with each matching network associated with at least one of the frequencies that the device can operate within. In other words, each matching network is associated with a particular frequency that the antennas or multi-band antenna can be tuned to. Once the system has identified the frequency of the communication network, the system can select a matching network that corresponds to the frequency that the multi-band antenna will be tuned to operate within. A single matching network may work for more than one frequency band. Each of the one or more matching networks may be a circuit that results in PI or T type filtering, for example, through the use of one or more capacitors, which may include parasitic capacitors. The capacitors may serve as filters within the one or more matching networks. In an embodiment, one or more matching networks alters the impedance between the RF amplifier and the antenna. This alteration may reduce signal loss and optimize performance of the communication. Each of the matching networks is designed for a particular frequency band that then results in a desired impedance within the circuit. Thus, each of the matching networks may include different components, numbers of components, values for components, or the like, than another matching network. Since each matching network is specifically designed for a particular frequency, the transmissions across the circuit can be optimized across that circuit. Accordingly, the mobile device can be designed to optimally perform on a variety of different frequency bands due to the fact that the device contains a plurality of matching networks that can be selected based upon the communication network frequency.

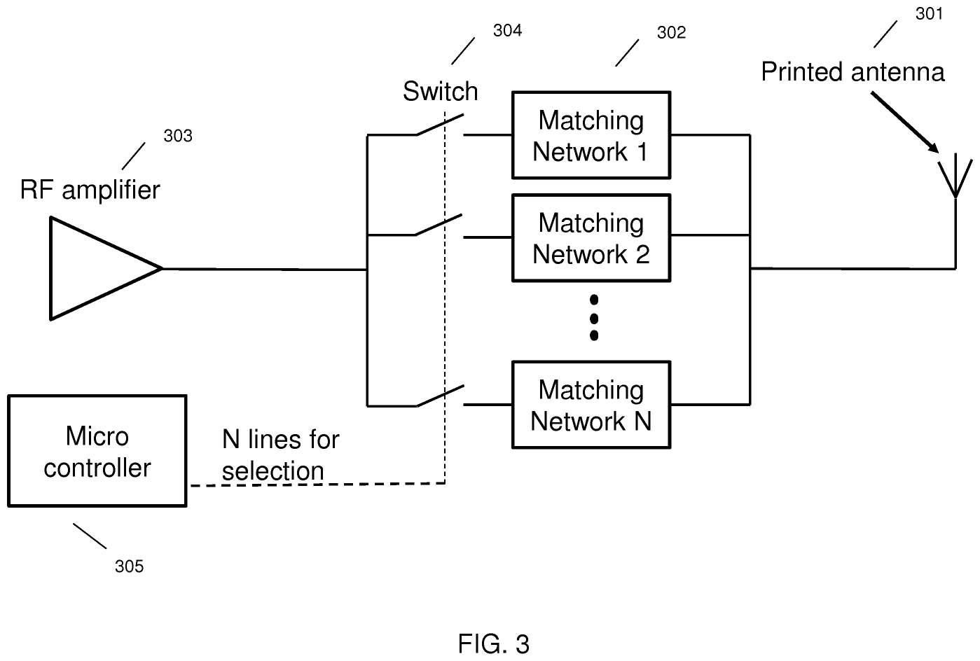

Referring to FIG. 3, in an embodiment, a plurality of switches may be placed in a circuit between an emitter 303 (e.g., RF amplifier) and a plurality of matching networks 302. The matching networks may be connected to a printed antenna 301, for example, the multi-band antenna of the device. There may be a switch 304 for each of the matching networks 302, where the switches may be controlled by a microcontroller 304 that controls the gate of the one or more switches. For example, the device may detect the predetermined frequency of the communication network and select a matching network corresponding to the communication network. Once this matching network is selected, the microprocessor may “close” the switch between the emitter and the selected matching network so that a circuit is completed between the emitter and the antenna through the selected matching network.

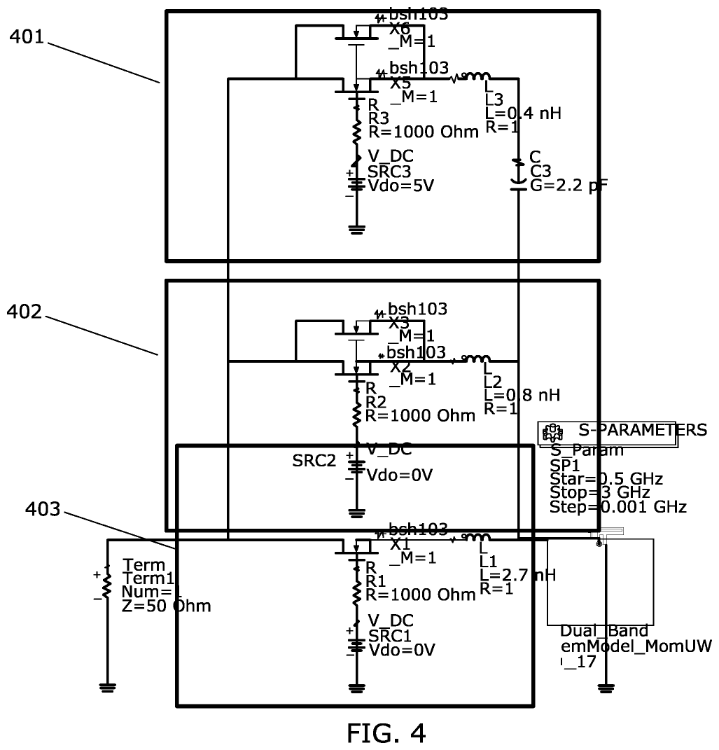

FIG. 4 illustrates an example matching network circuit, including a connection to an emitter and printed antenna. The one or more matching network circuits may be in parallel to one another. For example, in FIG. 4, the components for one matching network circuit may be represented as those components included in 401, the components for a second matching network circuitry may be represented as those components included in 402, and the components for a third matching network circuit may be represented as those components included in 403. It should be understood that circuitry for more than three matching networks may be included in an embodiment. As can be seen in FIG. 4, circuitry for some matching networks may share components with other matching network circuits, for example, matching network circuit 402 shares some components with matching network circuit 403. Some of the components included in the matching network circuits may include MOSFETs, capacitors, resistors, and the like.

In an embodiment, switching between different matching networks may be accomplished through the use of one or more MOSFETs. In other words, the MOSFET can be used as a switched capacitor that allows switching on and off of the matching network and allows tuning of the matching network cell to the desired frequency. For example, if the voltage between the gate source and the source is positive, then the MOSFET may be in a saturation mode. Thus, the resistance drain source is low requiring the matching network switch to turn on. The result of the switch for the matching network turning on results in an adaptation of the device to a predetermined frequency of the communication network. Alternatively, if the voltage between the gate and the source is high, then the MOSFET may be turned off. In this example, the matching network corresponding to the switched off MOSFET will not match the device frequency to that of the frequency of that particular matching network.

At 202 the system may determine whether a matching network can be selected based upon the communication network frequency. In other words, the system may determine whether the device can operate at the predetermined frequency and, if it can, selects the correct matching network. If the system can select a matching network, at 203, the system may connect an antenna to the identified communication network using the selected matching network. In other words, the system may select a matching network to communicate with the identified communication network based upon the frequency the that antenna is to be tuned to for communication with the communication network.

If a matching network can be selected the device may alert the user or the network. For example, the device may display which matched network is selected. An alert may be in a form of audio, visual, data, storing the data to a memory device, sending the output through a connected or wireless system, printing the output or the like. The system may log information such as the device type, communication network type, geographical location, time, date, network volume, or the like. The alert or log may be automated, meaning the system may automatically output that a matching network was not selected. The system may also have associated alarms, limits, or predetermined thresholds. For example, if a frequency of the device reaches a threshold, the system may trigger an alarm, search for a more appropriate matching network, attempt to find another available communication network, or the like. Alarms or logs may be analyzed in real-time, stored for later use, or any combination thereof.

At 204, in an embodiment, if a matching network cannot be selected, the system may connect to a communication network without a matching network selection or using traditional connection techniques. Alternatively, in an embodiment, the system may select a matching network as close to the frequency of the identified communication network as possible. If a matching network is not selected, the system may be designed such that the antenna is disconnected from the emitter so that no parasitic radiation can occur. If a matching network cannot be selected the device may alert the user or the network. An alert may be in a form of audio, visual, data, storing the data to a memory device, sending the output through a connected or wireless system, printing the output or the like. If a matching network cannot be selected the system may log information such as the device type, communication network type, geographical location, time, date, network volume, or the like. The alert or log may be automated, meaning the system may automatically output that a matching network was not selected. The system may also have associated alarms, limits, or predetermined thresholds. For example, if a frequency of the device reaches a threshold, the system may trigger an alarm, search for a more appropriate matching network, attempt to find another available communication network, or the like. Alarms or logs may be analyzed in real-time, stored for later use, or any combination thereof.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device, where the instructions are executed by a processor. In the context of this document, a storage device is not a signal and “non-transitory” includes all media except signal media.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and products according to various example embodiments. It will be understood that the actions and functionality may be implemented at least in part by program instructions. These program instructions may be provided to a processor of a device, e.g., a hand held measurement device such as illustrated in FIG. 1, or other programmable data processing device to produce a machine, such that the instructions, which execute via a processor of the device, implement the functions/acts specified.

It is noted that the values provided herein are to be construed to include equivalent values as indicated by use of the term “about.” The equivalent values will be evident to those having ordinary skill in the art, but at the least include values obtained by ordinary rounding of the last significant digit.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method for matching an antenna to a network, comprising:
identifying a communication network having a predetermined frequency accessible to connect a multi-band antenna of a device that radiates at a plurality of frequencies, wherein the plurality of frequencies includes the predetermined frequency;
selecting one of a plurality of matching networks associated with the multi-band antenna based upon the predetermined frequency of the communication network, wherein each of the plurality of matching networks is associated with at least one of the plurality of frequencies; and
connecting the multi-band antenna to the identified communication network while employing the selected one of a plurality of matching networks.

2. The method of claim 1, wherein the multi-band antenna comprises a printed antenna.

3. The method of claim 1, wherein each of the plurality of matching networks are dedicated to one of the plurality of frequencies.

4. The method of claim 1, wherein, while the multi-band antenna is disconnected from any communication network, the multi-band antenna is disconnected from an emitter of the device housing the multi-band antenna.

5. The method of claim 1, wherein the matching network is selected using a field-effect transistor.

6. The method of claim 5, wherein each of the plurality of matching networks further comprises a plurality of capacitors.

7. The method of claim 1, wherein the matching network adapts impedance between an emitter of the device and the antenna to improve performance of the antenna at the predetermined frequency.

8. The method of claim 7, wherein the impedance is adjusted to a value that results in an impedance between the emitter and the antenna of 50 ohms at the predetermined frequency.

9. The method of claim 7, wherein the impedance is adjusted to a value that results in a standing wave ratio of 1 at the predetermined frequency.

10. The method of claim 1, wherein the communication network comprises a global system for mobile communications.

11. A device for matching an antenna to a network, comprising:
a processor; and
a memory device that stores instructions executable by the processor to:
identify a communication network having a predetermined frequency accessible to connect a multi-band antenna of a device that radiates at a plurality of frequencies, wherein the plurality of frequencies includes the predetermined frequency;
select one of a plurality of matching networks associated with the multi-band antenna based upon the predetermined frequency of the communication network, wherein each of the plurality of matching networks is associated with at least one of the plurality of frequencies; and
connect the multi-band antenna to the identified communication network while employing the selected one of a plurality of matching networks.

12. The device of claim 11, wherein the multi-band antenna comprises a printed antenna.

13. The device of claim 11, wherein each of the plurality of matching networks are dedicated to one of the plurality of frequencies.

14. The device of claim 11, wherein, while the multi-band antenna is disconnected from any communication network, the multi-band antenna is disconnected from an emitter of the device housing the multi-band antenna.

15. The device of claim 11, wherein the matching network is selected using a field-effect transistor.

16. The device of claim 15, wherein each of the plurality of matching networks further comprises a plurality of capacitors.

17. The device of claim 11, wherein the matching network adapts impedance between an emitter of the device and the antenna to improve performance of the antenna at the predetermined frequency.

18. The device of claim 17, wherein the impedance is adjusted to a value that results in at least one of: an impedance between the emitter and the antenna of 50 ohms at the predetermined frequency and a standing wave ratio of 1 at the predetermined frequency.

19. The device of claim 11, furthering comprising an apparatus that measures at least one property of water, wherein the at least one property is selected from the group consisting of: pH, alkalinity, chlorine content, turbidity, oxidation-reduction potential (ORP), hardness, and sodium.

20. A product for matching an antenna to a network, comprising:
a storage device having code stored therewith, the code being executable by the processor and comprising:
code that identifies a communication network having a predetermined frequency accessible to connect a multi-band antenna of a device that radiates at a plurality of frequencies, wherein the plurality of frequencies includes the predetermined frequency;
code that selects one of a plurality of matching networks associated with the multi-band antenna based upon the predetermined frequency of the communication network, wherein each of the plurality of matching networks is associated with at least one of the plurality of frequencies; and
code that connects the multi-band antenna to the identified communication network while employing the selected one of a plurality of matching networks.
